(19) United States
(12) Patent Application Publication
(10) Pub. No.: US 2021/0218713 A1
(43) Pub. Date: Jul. 15, 2021

(54) FIRST PROCESSING APPARATUS TO BE CONNECTED TO A SECOND PROCESSING APPARATUS, AND NON-TRANSITORY COMPUTER READABLE MEDIUM

(71) Applicant: FUJI XEROX CO., LTD., Tokyo (JP)

(72) Inventor: Yoshihiro FUJIMAKI, Kanagawa (JP)

(73) Assignee: FUJI XEROX CO., LTD., Tokyo (JP)

(21) Appl. No.: 17/033,678

(22) Filed: Sep. 25, 2020

(30) Foreign Application Priority Data
Jan. 14, 2020 (JP) 2020-003804

(51) Int. Cl. H04L 29/06

(52) U.S. Cl. CPC H04L 63/0414; H04L 63/101; H04L 63/0428

(57) ABSTRACT

A first processing apparatus is connected to a second processing apparatus so as to communicate with each other. The second processing apparatus is connected to an information providing apparatus so as to communicate with each other. The first processing apparatus includes a memory and at least one processor. The memory stores information concerning attributes of a user. The at least one processor is configured to: request, in accordance with an operation of the user, the second processing apparatus to execute processing; add, upon receiving information concerning the processing from the second processing apparatus, information concerning a first attribute of the user stored in the memory to the received information concerning the processing, the information concerning the first attribute of the user being information which is necessary for executing the processing and which is impossible for the second processing apparatus to obtain from the information providing apparatus; and execute the processing by using the information concerning the processing appended with the information concerning the first attribute of the user.

### CROSS-REFERENCE TO RELATED APPLICATIONS

This application is based on and claims priority under 35 USC 119 from Japanese Patent Application No. 2020-003804 filed Jan. 14, 2020.

### BACKGROUND

### (i) Technical Field

The present disclosure relates to a first processing apparatus to be connected to a second processing apparatus, and a non-transitory computer readable medium.

### (ii) Related Art

Japanese Unexamined Patent Application Publication No. 2009-075666 discloses the following technology which enables a user to use a service without causing a leakage of valuable data for the user to a service provider. A display displays an input screen sent from a service providing apparatus. A conversion processor obtains data input into the input screen, and specifies data input into an input portion indicated by conversion setting information as user data. The conversion processor then converts the specified user data into conversion data. The conversion processor specifies data positioned at an output portion indicated by the conversion setting information on an output screen. The conversion processor then converts this specified data into user data indicated by conversion result information indicating that this specified data is the conversion data converted from the user data. The display displays an output screen on which the specified data is replaced by the user data.

### SUMMARY

A first processing apparatus is connected to a second processing apparatus so that they can communicate with each other. The second processing apparatus is connected to an information providing apparatus so that they can communicate with each other. The first processing apparatus requests the second processing apparatus to execute processing. In this case, the second processing apparatus obtains information concerning attributes of a user using the first processing apparatus from the information providing apparatus and then executes processing. In this configuration, information concerning attributes that the user does not wish to disclose is also sent to the second processing apparatus and is stored therein. This may cause a leakage of the information from the second processing apparatus.

Aspects of non-limiting embodiments of the present disclosure relate to a first processing apparatus, a second processing apparatus, and a non-transitory computer readable medium in which processing can be executed with enhanced security, compared with the configuration in which, when executing processing in response to a request from the first processing apparatus, the second processing apparatus obtains information concerning attributes of a user of the first processing apparatus from an information providing apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a first processing apparatus. The first processing apparatus is connected to a second processing apparatus so as to communicate with each other. The second processing apparatus is connected to an information providing apparatus so as to communicate with each other. The first processing apparatus includes a memory and at least one processor. The memory stores information concerning attributes of a user. The at least one processor is configured to: request, in accordance with an operation of the user, the second processing apparatus to execute processing; add, upon receiving information concerning the processing from the second processing apparatus, information concerning a first attribute of the user stored in the memory to the received information concerning the processing, the information concerning the first attribute of the user being information which is necessary for executing the processing and which is impossible for the second processing apparatus to obtain from the information providing apparatus; and execute the processing by using the information concerning the processing appended with the information concerning the first attribute of the user.

### BRIEF DESCRIPTION OF THE DRAWINGS

An exemplary embodiment of the present disclosure will be described in detail based on the following figures, wherein:

FIG. 1 is a block diagram illustrating conceptual modules forming an example of the configuration of the exemplary embodiment (processing apparatus A);

FIG. 2 is a block diagram illustrating conceptual modules forming an example of the configuration of the exemplary embodiment (processing apparatus B);

FIG. 3 is a block diagram illustrating an example of the system configuration utilizing the exemplary embodiment;

FIG. 4 is a flowchart illustrating an example of processing which does not utilize the exemplary embodiment;

FIG. 5 is a flowchart illustrating an example of processing executed in accordance with the exemplary embodiment;

FIGS. 6A and 6B are a flowchart illustrating an example of processing executed in accordance with the exemplary embodiment;

FIG. 7 illustrates an example of a logic definition handled in the exemplary embodiment;

FIG. 8 illustrates an example of logic handled in the exemplary embodiment;

FIG. 9 illustrates an example of processing executed in accordance with the exemplary embodiment;

FIGS. 10A and 10B are a flowchart illustrating an example of processing executed in accordance with the exemplary embodiment;

FIG. 11 illustrates an example of the data structure of a management table;

FIGS. 12A, 12B, and 12C are a flowchart illustrating an example of processing executed in accordance with the exemplary embodiment; and

FIG. 13 illustrates an example of the data structure of a parent-minor management table.

### DETAILED DESCRIPTION

An exemplary embodiment of the disclosure will be described below with reference to the accompanying drawings.

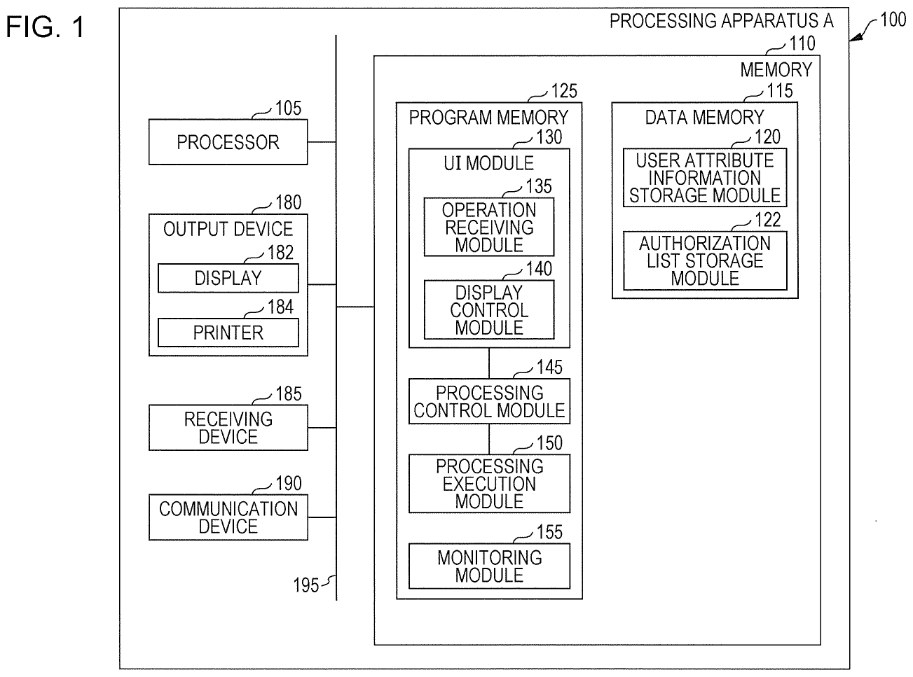

FIG. 1 is a block diagram illustrating conceptual modules forming an example of the configuration of the exemplary embodiment (processing apparatus A 100).

Generally, modules are software (computer programs) components or hardware components that can be logically separated from one another. The modules of the exemplary embodiment of the disclosure are, not only modules of a computer program, but also modules of a hardware configuration. Thus, the exemplary embodiment will also be described in the form of a computer program for allowing a computer to function as those modules (a program for causing a computer to execute program steps, a program for allowing a computer to function as corresponding units, or a computer program for allowing a computer to implement corresponding functions), a system, and a method. While expressions such as “store”, “storing”, “being stored”, and equivalents thereof are used for the sake of description, such expressions indicate, when the exemplary embodiment relates to a computer program, storing the computer program in a storage device or performing control so that the computer program will be stored in a storage device. Modules may correspond to functions based on a one-to-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationships among data elements, login, etc.). The term “predetermined” means being determined prior to a certain operation, and includes the meaning of being determined prior to a certain operation before starting processing of the exemplary embodiment, and also includes the meaning of being determined prior to a certain operation even after starting processing of the exemplary embodiment, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether the case A is satisfied, and B is performed if it is determined that the case A is satisfied”, unless such a determination is unnecessary. If elements are enumerated, such as “A, B, and C”, they are only examples unless otherwise stated, and such enumeration includes the meaning that only one of them (only the element A, for example) is selected.

A system or an apparatus (or a device) may be implemented by connecting plural computers, hardware units, devices, etc., to one another via a communication medium, such as a network (including communication connection based on a one-to-one correspondence), or may be implemented by a single computer, hardware unit, device, etc. The terms “apparatus” and “system” are used synonymously. The term “system” does not include a mere man-made social “mechanism” (social system).

Additionally, every time an operation is performed by using a corresponding module or every time each of plural operations is performed by using a corresponding module, target information is read from a storage device, and after performing the operation, a processing result is written into the storage device. A description of reading from the storage device before an operation or writing into the storage device after an operation may be omitted.

The processing apparatus A 100 has a function of executing processing while protecting information concerning user attributes. The processing apparatus A 100 is an example of a first processing apparatus.

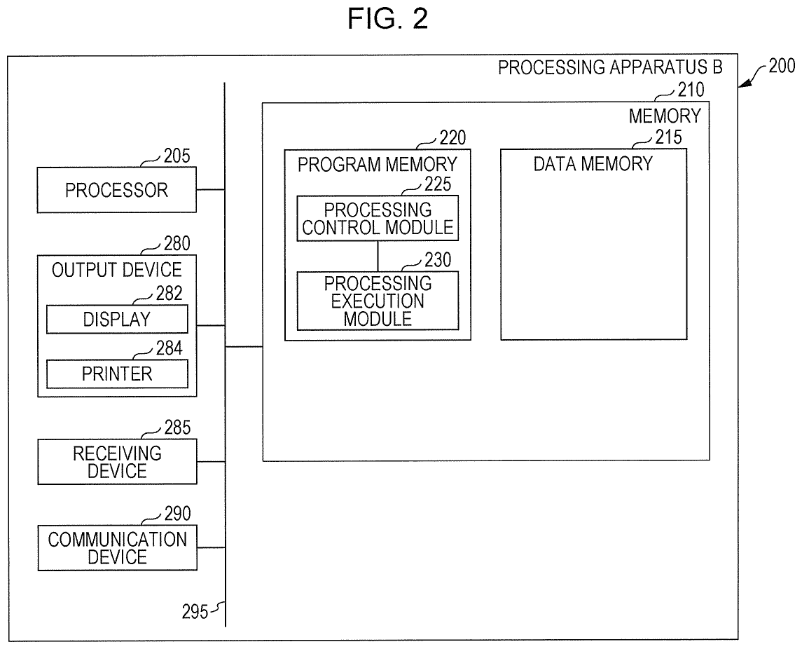

As shown in FIG. 1, the processing apparatus A 100 at least includes a processor 105 and a memory 110. A bus 195 connects the processor 105 and the memory 110 so that they can exchange data therebetween. The processing apparatus A 100 may also include an output device 180, a receiving device 185, and a communication device 190. Data is exchanged between the processor 105, the memory 110, the output device 180, the receiving device 185, and the communication device 190 via the bus 195. The processing apparatus A 100 is connected to a processing apparatus B 200 shown in FIG. 2 so that they can communicate with each other.

The block diagram of FIG. 1 also illustrates an example of the hardware configuration of a computer implementing the exemplary embodiment. The computer on which a program serving as the exemplary embodiment is executed has a hardware configuration, such as that shown in FIG. 1, and more specifically, the computer is a mobile terminal or a personal computer (PC) (including a notebook PC) for individual use. The processing apparatus A 100 shown in FIG. 1 includes the processor 105 as a processing unit and the memory 110 as a storage device.

As the processor 105, one or multiple processors may be used. The processor 105 may include a central processing unit (CPU) or a microprocessor, for example. If multiple processors 105 are used, they may be implemented as either one of a tightly coupled multiprocessor and a loosely coupled multiprocessor. For example, multiple processor cores may be loaded within a single processor 105. A system in which plural computers connect with each other via a communication channel so as to behave like one computer in a virtual manner may be utilized. As a specific example, multiple processors 105 may be a loosely coupled multiprocessor and be formed as a cluster system or a computer cluster. The processor 105 executes programs stored in a program memory 125. Hereinafter, an expression, such as “an X module in the program memory 125 executes processing”, will be used. This expression means that a program stored in the X module in the program memory 125 describes the content of processing to be executed by the processor 105 or that the processor 105 executes processing in accordance with the X module in the program memory 125.

The memory 110 may include semiconductor memory units within the processor 105, such as a register and a cache memory. The memory 110 may include a main memory device (main storage device) constituted by a random access memory (RAM) and a read only memory (ROM), for example, an internal storage device having a function as a persistent storage, such as a hard disk drive (HDD) and a solid state drive (SDD), and an external storage device and an auxiliary storage device, such as a compact disc (CD), a digital versatile disk (DVD), a Blu-ray (registered trademark) disc, a universal serial bus (USB) memory, and a memory card. The memory 110 may also include a storage, such as a server, connected to the first processing apparatus A 100 via a communication network.

The memory 110 includes as major elements a program memory 125 principally storing programs and a data memory 115 principally storing data. In the program memory 125, in addition to the module programs shown in FIG. 1, programs, such as an operating system (OS) for starting the computer, may be stored. In the data memory 115, in addition to the storage modules shown in FIG. 1, data, such as parameters that appropriately change during the execution of the module programs, may be stored.

The output device 180 includes a display 182 and a printer 184, for example. The display 182 is a liquid crystal display, an organic electroluminescence (EL) display, or a three-dimensional (3D) display, for example. The display 182 displays processing results of the processor 105 and data stored in the data memory 115 as text or image information, for example. The printer 184, which is a printing device or a multifunction device, prints processing results of the processor 105 and data stored in the data memory 115, for example. The output device 180 may include a speaker and an actuator for vibrating equipment.

The receiving device 185 receives data based on an operation (including motion, voice, and gaze) performed on a keyboard, a mouse, a microphone, or a camera (including a gaze detection camera) by a user or image data generated in response to a reading operation of a scanner.

A device having both the functions of the display 182 and the receiving device 185, such as a touchscreen, may be used. In this case, to implement the function of the keyboard, a keyboard drawn on the touchscreen by using software, that is, a software keyboard or a screen keyboard, may be used instead of a physical keyboard.

As a user interface (UI), the display 182 and the receiving device 185 are principally used.

The communication device 190 is a communication network interface, such as a network card, for enabling the processing apparatus A 100 to connect to another apparatus via a communication network. Examples of the apparatuses to which the processing apparatus A 100 is to be connected are a processing apparatus B 200, an information providing apparatus 310, and a processing apparatus C1 320.

In the above-described exemplary embodiment, concerning elements implemented by a software computer program, such a computer program is stored in the program memory 125 having the hardware configuration shown in FIG. 1 or a program memory 220 having the hardware configuration shown in FIG. 2, and the processor 105 or 205 reads the computer program, thereby implementing the exemplary embodiment by a combination of software and hardware resources.

The hardware configurations in FIGS. 1 and 2 are only examples, and the exemplary embodiment may be configured in any manner if the modules described in the exemplary embodiment are executable. For example, as the processor 105, a graphics processing unit (GPU) or a general-purpose computing on graphics processing unit (GPGPU) may be used. Some modules may be configured as dedicated hardware, for example, an application specific integrated circuit (ASIC) or a field-programmable gate array (FPGA), or some modules may be installed in an external system and be connected to the processing apparatus A 100 or B 200 via a communication network. A system, such as that shown in FIGS. 1 or 2, may be connected to a system, such as that shown in FIGS. 1 or 2, via a communication network, and may be operated in cooperation with each other. Additionally, instead of into a PC, the modules may be integrated into a mobile information communication device (including a cellular phone, a smartphone, a mobile device, and a wearable computer), a home information appliance, a robot, a copying machine, a fax machine, a scanner, a printer, and a multifunction device (an image processing apparatus including at least two of the functions of a scanner, a printer, a copying machine, and a fax machine).

The processor 105 is connected to the memory 110, the output device 180, the receiving device 185, and the communication device 190 via the bus 195. The processor 105 executes processing in accordance with a computer program describing an execution sequence of each module, which is a program stored in the program memory 125. For example, in response to the receiving device 185 receiving a user operation, the processor 105 executes processing by using the module corresponding to the received operation, and stores the processing result in the data memory 115, outputs it to the display 182, or controls the communication device 190 to send the processing result to another apparatus.

The memory 110 includes the data memory 115 and the program memory 125 and is connected to the processor 105, the output device 180, the receiving device 185, and the communication device 190 via the bus 195.

The data memory 115 stores a user attribute information storage module 120 and an authorization list storage module 122.

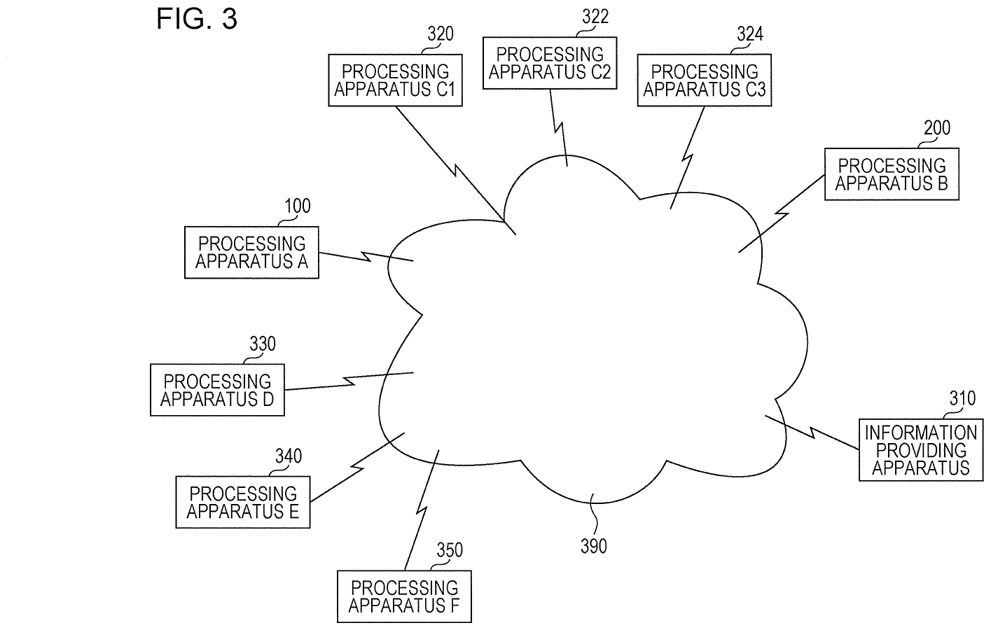

The user attribute information storage module 120 stores information concerning attributes of a user. The information concerning attributes of a user is information concerning the qualities and characteristics unique to the user, such as the abilities, background, social relationships, and personal information concerning the user. Regarding such information concerning a user, some items of information are those that the user is not unwilling to store in the processing apparatus B 200 shown in FIG. 2 and/or the information providing apparatus 310 shown in FIG. 3, while some items of information are those that the user is unwilling to store in the processing apparatus B 200 and/or the information providing apparatus 310. The first type of information may also be called disclosed attribute information, that is, information which can be open to the public, while the second type of information may also be called undisclosed attribute information, that is, sensitive personal information which is unable to be open to the public. An example of undisclosed attribute information is information which is necessary for doing shopping or carrying out an administrative procedure. Specific examples of undisclosed attribute information are credit card numbers and individual numbers (ID numbers). Undisclosed attribute information concerning a user is not stored in the information providing apparatus 310 but is stored in the user attribute information storage module 120 of the processing apparatus A 100 used by the user. Alternatively, undisclosed attribute information may be stored in the information providing apparatus 310 but is not provided to the processing apparatus B 200.

The user attribute information storage module 120 may be provided for each application, or it may be used for multiple applications. If the same user attribute information storage module 120 is used for multiple applications, it is not necessary to set undisclosed attribute information for each application. For example, the updating of a credit card number can be performed at the same time together for the multiple applications.

The authorization list storage module 122 stores a list of external processing apparatuses to which the processing apparatus A 100 can made access. If the processing apparatus A 100 can make access to an external processing apparatus, it means that the processing apparatus A 100 can access this external apparatus without any caution. The authorization list storage module 122 stores a so-called whitelist of external apparatuses. Examples of whitelisted external apparatuses are a server, a cloud system, a file system, and a process.

The program memory 125 stores a UI module 130, a processing control module 145, a processing execution module 150, and a monitoring module 155. The modules stored in the program memory 125 are executed by the processor 105.

The UI module 130 includes an operation receiving module 135 and a display control module 140, and is connected to the processing control module 145. The UI module 130 executes processing concerning UIs.

The operation receiving module 135 detects a user operation received by the receiving device 185. Examples of a user operation are an operation for starting an application, an input operation required to execute an application, and a login operation.

The display control module 140 performs control to display processing results obtained by the processing control module 145, the processing execution module 150, and the monitoring module 155 on the display 182.

The processing control module 145 is connected to the UI module 130 and the processing execution module 150. The processing control module 145 controls processing to be executed by the processing execution module 150 and the monitoring module 155, for example.

In accordance with a user operation received by the receiving device 185, the processing control module 145 requests via the communication device 190 the processing apparatus B 200 to execute processing. For example, the processing control module 145 requests the processing apparatus B 200 to start an application that the processing apparatus B 200 provides.

The processing execution module 150 is connected to the processing control module 145. It is now assumed that, when the processing apparatus B 200 executes processing in response to a request from the processing control module 145, it requires information concerning a user attribute but is unable to obtain it from the information providing apparatus 310. Upon receiving information concerning this processing from the processing apparatus B 200, the processing execution module 150 reads information concerning the user attribute from the user attribute information storage module 120 and adds the read information to the information concerning the processing, and then executes this processing by using the information concerning the processing appended with the information concerning the user attribute.

The information providing apparatus 310 manages user information. For example, the information providing apparatus 310 provides attribute information concerning a user to conduct authentication of this user, and implements single sign-on. In response to access from the processing apparatus A 100, the processing apparatus B 200 obtains user attribute information from the information providing apparatus 310.

The above-described information concerning processing is information necessary for the processing apparatus B 200 to execute processing in response to a request from the processing apparatus A 100. Such information is also called logic or business logic. Logic expresses information concerning a specific job, such as various entities (products, clients, and stock, for example) handled in this job, and the relationships among the entities, a processing method, and a job flow concerning this job are implemented as a program code or a data structure in an application executed by the processing apparatus B 200. Logic may be information describing application-specific processing or rules. For instance, regarding an application for purchasing a product at a desired price or lower, information necessary for making such a purchase and a program describing the processing content are included in the application. More specifically, as information necessary for purchasing a certain product by a user, information concerning the product name, the number of pieces, desired price, address, and credit card number of the user is included in the application. Among the above-described items of information, the processing apparatus B 200 is able to obtain the product name, the number of pieces, and desired price from the processing apparatus A 100 and the address from the information providing apparatus 310. Regarding the credit card number, however, if it is not stored in the information providing apparatus 310 or if the information providing apparatus 310 stores the credit card number but is not authorized to supply it to the processing apparatus B 200 by a specific setting set by the user, the processing apparatus B 200 is unable to obtain information on the credit card number. The processing apparatus B 200 thus generates information concerning processing with an undefined credit card number. The processing apparatus B 200 then sends this information to the processing apparatus A 100. Upon receiving this information, the processing apparatus A 100 adds information on the credit card number to the received information and executes processing based on the received information. That is, processing which would normally be executed by the processing apparatus B 200 is executed by the processing apparatus A 100. In other words, the processing apparatus B 200 executes preprocessing, which is the previous stage of the processing to be executed by the processing apparatus A 100. That is, the processing apparatus B 200 generates a program for executing the processing. In this program, information on the credit card number is not included.

Regarding the processing that the processing apparatus A 100 has requested the processing apparatus B 200 to execute, the processing apparatus A 100 may send information concerning the processing to another processing apparatus, which is not yet determined, via the processing apparatus B 200.

At a time point when the processing apparatus A 100 has requested the processing apparatus B 200 to execute processing, the processing apparatus to which the information concerning the processing will be sent is not yet determined. There may be multiple options to which the information concerning the processing will be sent. There may be only one option to which the information concerning the processing will be sent, but the processing apparatus A 100 does not identify this apparatus because it is not yet determined. The processing apparatus B 200 determines which processing apparatus will receive the information concerning the processing. It is now assumed that a processing apparatus C1 320 will receive this information and executes processing.

The processing apparatus A 100 may read information concerning a user attribute from the user attribute information storage module 120 and add it to the information concerning the processing. The processing apparatus A 100 then sends this information to the processing apparatus C1 320.

The information concerning this user attribute stored in the user attribute information storage module 120 is undisclosed attribute information, such as a credit card number and an individual number (ID number).

When the processing apparatus A 100 accesses an external processing apparatus, the monitoring module 155 judges whether this external processing apparatus is an authorized apparatus included in a list stored in the authorization list storage module 122. If the external processing apparatus is an authorized apparatus, the monitoring module 155 permits the processing apparatus A 100 to access this external processing apparatus. If the external processing apparatus is not an authorized apparatus, the monitoring module 155 does not permit the processing apparatus A 100 to access this external processing apparatus.

The processing apparatus B 200 that communicates with the processing apparatus A 100 will be described below. The processing apparatus B 200 is an example of a second processing apparatus.

The processing apparatus B 200 has a function of executing processing while protecting information concerning user attributes. FIG. 2 is a block diagram illustrating conceptual modules forming an example of the configuration of the exemplary embodiment (processing apparatus B 200).

As shown in FIG. 2, the processing apparatus B 200 at least includes a processor 205 and a memory 210. A bus 295 connects the processor 205 and the memory 210 so that they can exchange data therebetween. The processing apparatus B 200 may also include an output device 280, a receiving device 285, and a communication device 290. Data is exchanged between the processor 205, the memory 210, the output device 280, the receiving device 285, and the communication device 290 via the bus 295. Although data stored in a data memory 215 and programs stored in a program memory 220 are different from the counterparts of the processing apparatus A 100, the other modules and functions of the processing apparatus B 200 are equivalent to those of the processing apparatus A 100. An explanation of such modules and functions of the processing apparatus B 200 will thus be omitted. The performance of the functions of the processing apparatus B 200, such as the resolution of a display 282 and the memory capacity of the memory 210, may be different from that of the processing apparatus A 100.

The processing apparatus B 200 is connected to the processing apparatus A 100 shown in FIG. 1 and the information providing apparatus 310 shown in FIG. 3 so that they can communicate with each other.

The block diagram of FIG. 2 also illustrates an example of the hardware configuration of a computer implementing the exemplary embodiment. The computer on which a program serving as the exemplary embodiment is executed has a hardware configuration, such as that shown in FIG. 2, and more specifically, the computer is a server computer. The processing apparatus B 200 shown in FIG. 2 includes the processor 205 as a processing unit and the memory 210 as a storage device.

The processor 205 is connected to the memory 210, the output device 280, the receiving device 285, and the communication device 290 via the bus 295. The processor 205 has functions equivalent to those of the processor 105 of the processing apparatus A 100.

The output device 280 includes a display 282 and a printer 284, and is connected to the processor 205, the memory 210, the receiving device 285, and the communication device 290 via the bus 295. The output device 280 has functions equivalent to those of the output device 180 of the processing apparatus A 100.

The display 282 has functions equivalent to those of the display 182 of the processing apparatus A 100.

The printer 284 has functions equivalent to those of the printer 184 of the processing apparatus A 100.

The receiving device 285 is connected to the processor 205, the memory 210, the output device 280, and the communication device 290 via the bus 295. The receiving device 285 has functions equivalent to those of the receiving device 185 of the processing apparatus A 100.

The communication device 290 is connected to the processor 205, the memory 210, the output device 280, and the receiving device 285 via the bus 295. The communication device 290 has functions equivalent to those of the communication device 190 of the processing apparatus A 100. Examples of apparatuses to which the communication device 290 is to be connected are the processing apparatus A 100, the information providing apparatus 310, a processing apparatus D 330, a processing apparatus E 340, and a processing apparatus F 350.

The memory 210 includes a data memory 215 and a program memory 220, and is connected to the processor 205, the output device 280, the receiving device 285, and the communication device 290 via the bus 295.

The data memory 215 stores data necessary for executing processing by the modules in the program memory 220. If, however, there is information concerning a user attribute which is necessary for executing processing by the processing apparatus B 200 but is impossible to obtain from the information providing apparatus 310, such information is not stored in the data memory 215.

The program memory 220 includes a processing control module 225 and a processing execution module 230. The modules stored in the program memory 220 are executed by the processor 205.

The processing control module 225 controls processing to be executed by the processing execution module 230, for example.

It is now assumed that, when the processing apparatus B 200 executes processing in response to a request from the processing apparatus A 100, it requires information concerning an attribute of a user but is unable to obtain it from the information providing apparatus 310. In this case, the processing execution module 230 generates information concerning the processing without including information concerning this attribute of the user, and sends the generated information to the processing apparatus A 100.

Regarding processing that the processing apparatus A 100 has requested the processing apparatus B 200 to execute, the processing execution module 230 may request, via the processing apparatus B 200, another processing apparatus (processing apparatus C1 320, for example) to execute this processing, in accordance with the information concerning the processing. At this time point, it is not yet determined which processing apparatus will execute the processing. The processing apparatus B 200 determines the processing apparatus (processing apparatus C1 320, for example) that executes the processing.

FIG. 3 is a block diagram illustrating an example of the system configuration utilizing the exemplary embodiment.

The processing apparatus A 100, the processing apparatus B 200, the information providing apparatus 310, the processing apparatus C1 320, a processing apparatus C2 322, a processing apparatus C3 324, a processing apparatus D 330, a processing apparatus E 340, and a processing apparatus F 350 are connected with one another via a communication network 390. The communication network 390 may be a wireless or wired medium, or a combination thereof, and may be, for example, the Internet or an intranet as a communication infrastructure. The functions of the processing apparatus B 200, the information providing apparatus 310, the processing apparatus C1 320, the processing apparatus C2 322, the processing apparatus C3 324, and the processing apparatus D 330 may be implemented as cloud services.

The processing apparatus A 100, the processing apparatus E 340, and the processing apparatus F 350 are user terminals, such as mobile terminals and PCs used by users. The processing apparatus A 100, the processing apparatus E 340, and the processing apparatus F 350 are able to access the processing apparatus B 200 via a browser and cause the processing apparatus B 200 to execute an application.

The processing apparatus B 200 is a server, for example, that executes an application in response to an instruction from a user using the processing apparatus A 100, the processing apparatus E 340, or the processing apparatus F 350. The processing apparatus B 200 obtains information concerning attributes of this user from the information providing apparatus 310. The processing apparatus B 200 may alternatively request the processing apparatus C1 320, the processing apparatus C2 322, or the processing apparatus C3 324, for example, to execute the application. If the processing apparatus B 200 has failed to obtain information concerning attributes of the user from the information providing apparatus 310, it may request the processing apparatus A 100, the processing apparatus D 330, or the processing apparatus F 350 to execute processing. That is, the processing apparatus B 200 provides a service for executing processing on behalf of another apparatus.

The information providing apparatus 310 stores information concerning attributes of users using the processing apparatus A 100, the processing apparatus E 340, and the processing apparatus F 350. The information providing apparatus 310 provides information concerning attributes of the user using the processing apparatus A 100, for example, to the processing apparatus B 200. However, there may be some items of information that the information providing apparatus 310 is unable to provide to the processing apparatus B 200. In other words, there are some items of information that the processing apparatus B 200 is unable to obtain from the information providing apparatus 310. The reason for this is that the information providing apparatus 310 does not store such items of information or it is not authorized to provide them to the processing apparatus B 200 by a specific setting set by the user.

A specific example of the information providing apparatus 310 is an apparatus based on OAuth2, and more specifically, an identity provider (IdP). IdP is a device which provides authentication information based on security assertion markup language (SAML) authentication. SAML authentication implements single sign-on to enable a user to sign onto multiple cloud services. SAML also makes it possible to provide information concerning attributes of a user. That is, SAML makes it possible to manage personal information concerning a user, such as the address and the credit card number, as well as to conduct authentication of this user. Nonetheless, the user may not always register the credit card number in an IdP, or it may register it in an IdP but may not permit the IdP to provide the credit card number to the processing apparatus B 200 by a special setting.

The processing apparatus C1 320, the processing apparatus C2 322, and the processing apparatus C3 324 are examples of a third processing apparatus. They execute practical processing of an application. By taking the above-described application for purchasing a product at a desired price or lower as an example, the processing apparatus C1 320, for example, is a cloud system which provides a service for selling this product. To purchase this product, the credit card number of a user is required. If the processing apparatus B 200 is able to obtain this credit card number from the information providing apparatus 310, it purchases this product from the processing apparatus C1 320 for the user. If the processing apparatus B 200 is unable to obtain this credit card number from the information providing apparatus 310, it generates logic, which is a program for enabling the processing apparatus A 100 to purchase the product from the processing apparatus C1 320. In this logic, a field of the credit card number for making a payment is left blank. The processing apparatus B 200 sends this logic to the processing apparatus A 100. Upon receiving this logic, the processing apparatus A 100 inputs the credit card number into the blank field in the logic, sends the logic to the processing apparatus C1 320, and purchases the product from the processing apparatus C1 320.

The processing apparatus D 330 is an example of a fourth processing apparatus. The processing apparatus D 330 stores, as a backup, information concerning user attributes stored in the processing apparatus A 100 (and more precisely, information concerning user attributes that the processing apparatus B 200 is unable to obtain from the information providing apparatus 310). If the processing apparatus B 200 becomes unable to communicate with the processing apparatus A 100, the processing apparatus D 330 executes processing on behalf of the processing apparatus A 100. More specifically, after the processing apparatus A 100 has requested the processing apparatus B 200 to execute processing, if the processing apparatus B 200 becomes unable to communicate with the processing apparatus A 100, the processing apparatus D 330 acts for the processing apparatus A 100. This can be explained through the following situation, for example. After the processing apparatus A 100 has requested the processing apparatus B 200 to execute processing, the user of the processing apparatus A 100 tends to consider that it is no longer necessary for the processing apparatus A 100 to execute processing because the processing apparatus B 200 has already undertaken to execute processing. The user may then power OFF the processing apparatus A 100, which stops it from executing processing any further. Even in this situation, the processing apparatus D 330 stores information concerning user attributes stored in the processing apparatus A 100 and can thus execute processing on behalf of the processing apparatus A 100.

As in the processing apparatus A 100, the processing apparatus E 340 is able to request the processing apparatus B 200 to execute processing. It is now assumed that the user of the processing apparatus E 340 is a minor (who is not legally an adult) and may not possess a credit card. In this case, this user may have to use a credit card of his/her parent.

The processing apparatus F 350 is an example of a fifth processing apparatus. It is assumed that the processing apparatus F 350 is used by a parent of the above-described minor. In this manner, when a minor user without a credit card wishes to make a purchase, the processing apparatus B 200 generates information concerning processing without including information concerning attributes of a parent user, and sends the generated information to the processing apparatus F 350. The processing apparatus F 350 sends this information to the processing apparatus C1 320, and the processing apparatus C1 320 executes processing for making a purchase. When executing processing for making a purchase, the processing apparatus C1 320 may ask for approval from the parent user, who is the user of the processing apparatus F 350. That is, if the processing apparatus C1 320 has succeeded in obtaining approval from the parent user, it executes processing for making a purchase. If the processing apparatus C1 320 has failed to obtain approval from the parent user, it terminates processing.

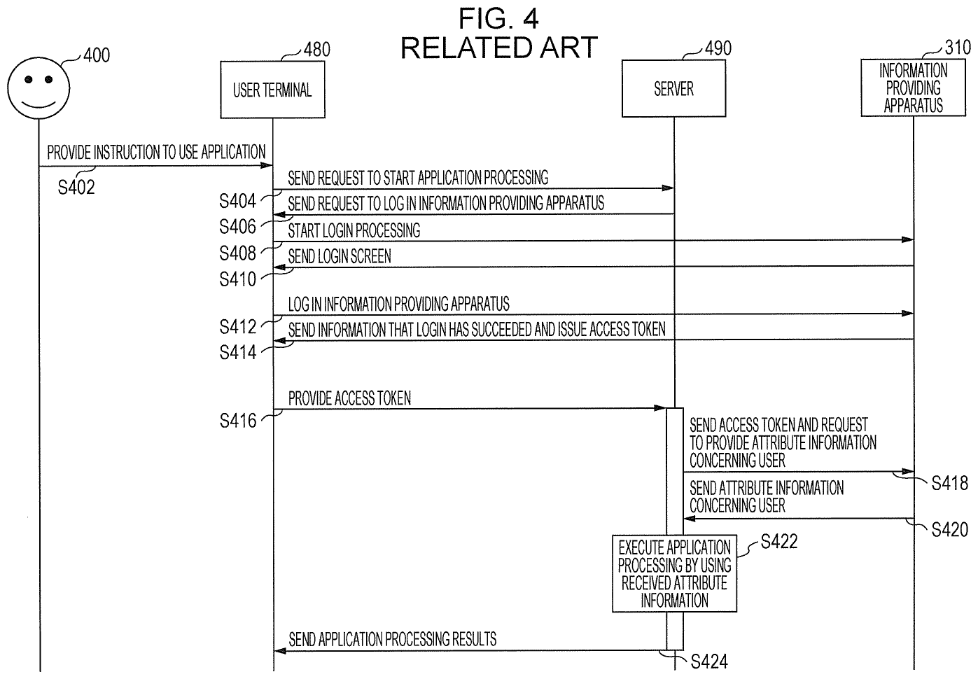

FIG. 4 is a flowchart illustrating an example of processing which does not utilize the exemplary embodiment.

A user terminal 480 has typical application functions called frontend functions, such as smartphone application functions, but does not have the functions of the processing apparatus A 100 of the exemplary embodiment.

A server 490 has typical application functions called backend functions, but does not have the functions of the processing apparatus B 200 of the exemplary embodiment.

Steps S402 through S416 are based on an access token issuing protocol, such as OAuth2.

In step S402, a user 400 provides an instruction to use an application by using the user terminal 480.

In step S404, the user terminal 480 requests the server 490 to start application processing.

In step S406, the server 490 requests the user terminal 480 to log in the information providing apparatus 310.

In step S408, the user terminal 480 starts login processing to log in the information providing apparatus 310.

In step S410, the information providing apparatus 310 sends a login screen to the user terminal 480. An example of the login screen is a screen for inputting a user ID and a password.

In step S412, the user terminal 480 logs in the information providing apparatus 310. For example, the user terminal 480 sends a user ID and a password to the information providing apparatus 310 in accordance with the operation of the user 400.

In step S414, if a combination of the user ID and the password sent from the user terminal 480 is valid, the information providing apparatus 310 notifies the user terminal 480 of the success of the login operation and issues an access token. If the login operation has failed, the process may return to step S410, or the processing is terminated.

In step S416, the user terminal 480 provides the access token to the server 490.

In step S418, the server 490 sends the access token to the information providing apparatus 310 and also requests the information providing apparatus 310 to provide attribute information concerning the user 400.

In step S420, the information providing apparatus 310 sends the attribute information concerning the user 400 to the server 490.

In step S422, the server 490 executes application processing by using the attribute information obtained from the information providing apparatus 310.

In step S424, the server 490 sends the results of application processing to the user terminal 480.

In a cloud system, to provide a service to the user 400, the server 490, which provides a service, and the information providing apparatus 310, such as an IdP, which provides and manages information concerning the user 400, are operated collaboratively.

In the above-described service providing model, the following mechanism is widely used. To provide a service to the user 400, the server 490 requires attribute information concerning the user 400. With authorization from the user 400, the server 490 can obtain the attribute information from the information providing apparatus 310. An example of this mechanism is OAuth2.

After the user 400 has authorized the server 490 to access the information providing apparatus 310, the information providing apparatus 310 issues an access token to the server 490 via the user terminal 480. The server 490 presents this access token if necessary and accesses the information providing apparatus 310 so as to obtain attribute information concerning the user 400.

For example, the server 490 is assumed to be a hotel booking site. With OAuth2, the server 490 obtains the email address of the user 400 from the information providing apparatus 310, and then, it can send a reminder email to the user 400 one week before the check-in date.

In this manner, the server 490 provides a service by obtaining the attribute information registered in the information providing apparatus 310 by the user 400. This, however, involves a risk of a leakage of the attribute information. That is, after the attribute information is obtained from the information providing apparatus 310, it is stored in the server 490. This may cause a leakage of the attribute information due to a cyberattack by a third party, for example. Additionally, the attribute information is sent from the information providing apparatus 310 to the server 490 via a communication network. This may cause a leakage of the attribute information due to interception when packet monitoring is performed on a communication network. That is, in the above-described model, the security issue arises.

On the other hand, if the user 400 does not authorize the server 490 to access the information providing apparatus 310 so as to protect personal information concerning the user 400, the server 490 is unable to provide a service to the user 400.

In the exemplary embodiment, with the processing apparatus A 100 and the processing apparatus B 200, even without or substantially without disclosing attribute information concerning a user to the processing apparatus B 200, which corresponds to the server 490, the provision of a service to the user can be implemented.

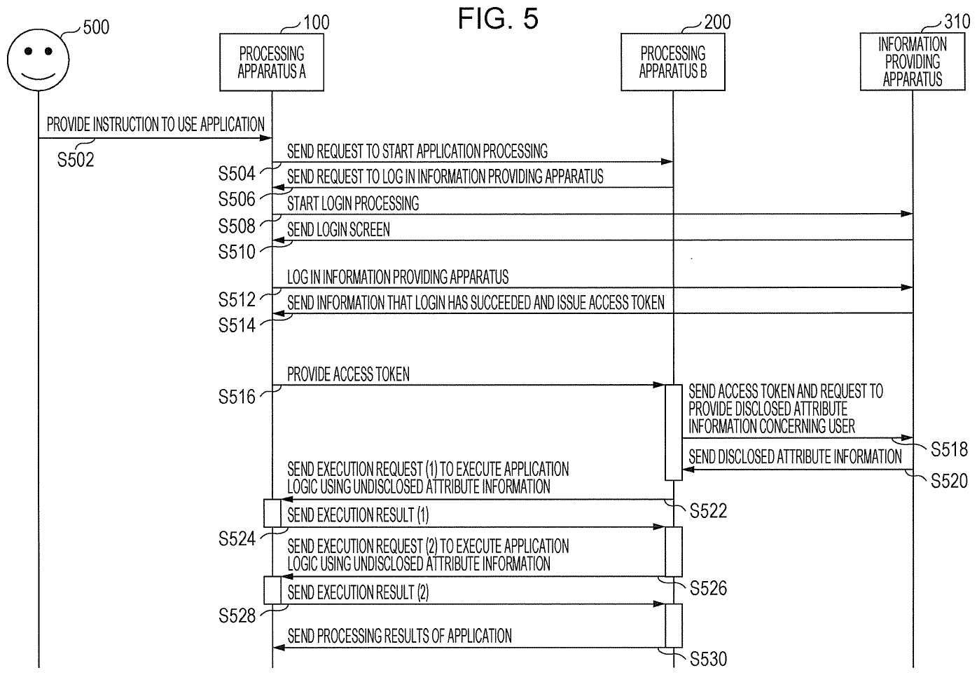

FIG. 5 is a flowchart illustrating an example of processing executed in accordance with the exemplary embodiment.

As in the processing in FIG. 4, steps S502 through S516 are based on an access token issuing protocol, such as OAuth2. That is, steps S502 through S516 are similar to steps S402 through S416 in the flowchart of FIG. 4.

In step S502, a user 500 provides an instruction to use an application by using the processing apparatus A 100.

In step S504, the processing apparatus A 100 requests the processing apparatus B 200 to start application processing.

In step S506, the processing apparatus B 200 requests the processing apparatus A 100 to log in the information providing apparatus 310.

In step S508, the processing apparatus A 100 starts login processing to log in the information providing apparatus 310.

In step S510, the information providing apparatus 310 sends a login screen to the processing apparatus A 100.

In step S512, the processing apparatus A 100 logs in the information providing apparatus 310.

In step S514, the information providing apparatus 310 notifies the processing apparatus A 100 of the success of the login operation and issues an access token.

In step S516, the processing apparatus A 100 provides the access token to the processing apparatus B 200.

In step S518, the processing apparatus B 200 sends the access token to the information providing apparatus 310 and also requests the information providing apparatus 310 to provide disclosed attribute information concerning the user 500.

In step S520, the information providing apparatus 310 sends the disclosed attribute information concerning the user 500 to the processing apparatus B 200. The information providing apparatus 310 does not or is unable to send undisclosed attribute information concerning the user 500 to the processing apparatus B 200.

In step S522, the processing apparatus B 200 sends an execution request (1) to execute application logic using the undisclosed attribute information to the processing apparatus A 100. In this example, the application logic is divided into two stages.

In step S524, the processing apparatus A 100 sends an execution result (1) to the processing apparatus B 200.

In step S526, the processing apparatus B 200 sends an execution request (2) to execute application logic using the undisclosed attribute information to the processing apparatus A 100.

In step S528, the processing apparatus A 100 sends an execution result (2) to the processing apparatus B 200.

In step S530, the processing apparatus B 200 sends the processing results of the application to the processing apparatus A 100.

According to the above-described processing, the application logic can be executed while the undisclosed attribute information concerning the user 500 remains being stored in the processing apparatus A 100 and is not disclosed to the outside.

The user 500 may feel as if the processing apparatus B 200 were executing processing because the user 500 merely provides an instruction to use an application to the processing apparatus A 100, as in FIG. 4.

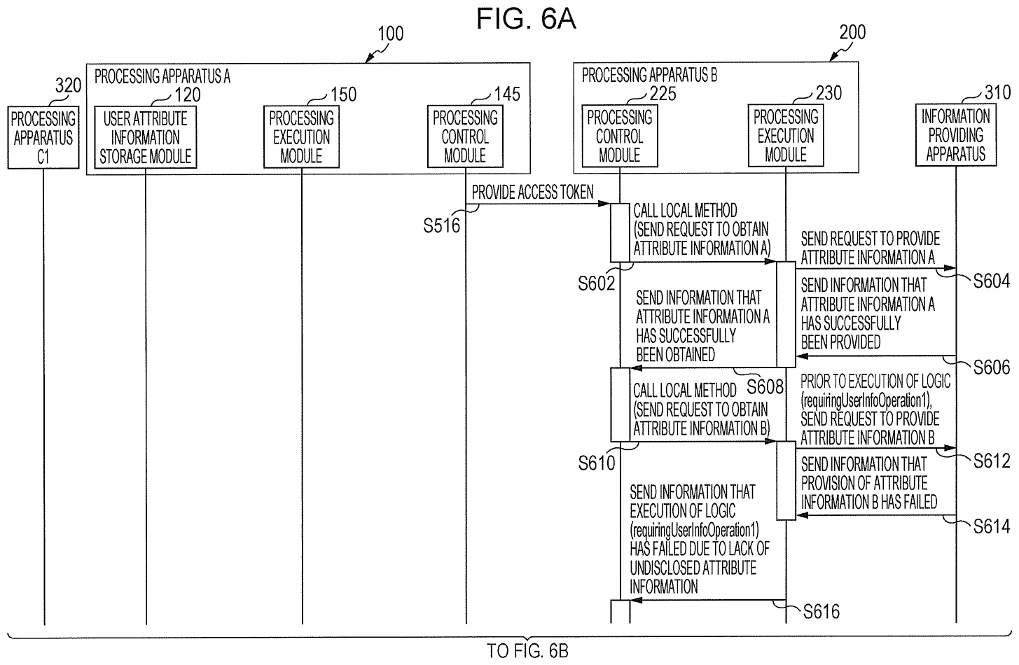

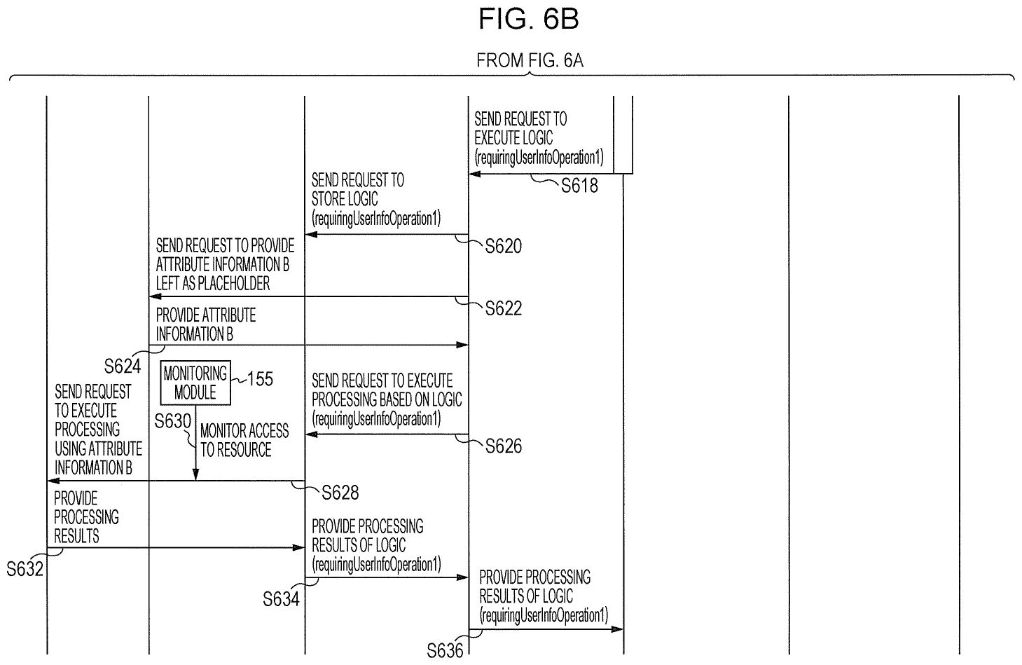

FIGS. 6A and 6B are a flowchart illustrating an example of processing executed in accordance with the exemplary embodiment. In FIGS. 6A and 6B, steps S516 through S528 in the flowchart of FIG. 5 are illustrated in detail. Regarding the execution request to execute the application logic in FIG. 5, a processing example of the execution request (1) is only shown in FIG. 6B, while processing of the execution request (2) is omitted. To execute processing of the execution request (2), after step S636, steps S618 through S636 are simply repeated.

In this processing example, logic (requiringUserInfoOperation1) is generated and executed. To execute this logic, attribute information A and attribute information B concerning the user 500 are required. The attribute information A is disclosed attribute information, while the attribute information B is undisclosed attribute information.

In step S516, the processing control module 145 of the processing apparatus A 100 provides the access token to the processing control module 225 of the processing apparatus B 200.

In step S602, the processing control module 225 gives a local method call to the processing execution module 230. In other words, the processing control module 225 sends a request to obtain the attribute information A to the processing execution module 230.

In step S604, the processing execution module 230 sends a request to provide the attribute information A concerning the user 500 to the information providing apparatus 310.

In step S606, the information providing apparatus 310 notifies the processing execution module 230 that the user attribute information A has successfully been provided.

In step S608, the processing execution module 230 notifies the processing control module 225 that the user attribute information A has successfully been obtained.

In step S610, the processing control module 225 gives a local method call to the processing execution module 230. In other words, the processing control module 225 sends a request to obtain the attribute information B to the processing execution module 230.

In step S612, prior to the execution of the logic (requiringUserInfoOperation1), the processing execution module 230 sends a request to provide the attribute information B concerning the user 500 to the information providing apparatus 310.

In step S614, the information providing apparatus 310 notifies the processing execution module 230 of a failure to provide the attribute information B. This is because the information providing apparatus 310 does not store the attribute information B, which is undisclosed attribute information.

In step S616, the processing execution module 230 notifies the processing control module 225 that it has failed to execute the logic (requiringUserInfoOperation1) due to the lack of undisclosed attribute information.

In step S618, the processing control module 225 requests the processing control module 145 to execute the logic (requiringUserInfoOperation1).

In step S620, the processing control module 145 requests the processing execution module 150 to store the logic (requiringUserInfoOperation1).

In step S622, the processing control module 145 requests the user attribute information storage module 120 to provide the attribute information B which is left as a placeholder (blank).

In step S624, the user attribute information storage module 120 provides the attribute information B to the processing control module 145.

In step S626, the processing control module 145 requests the processing execution module 150 to execute processing based on the logic (requiringUserInfoOperation1).

In step S628, the processing execution module 150 requests the processing apparatus C1 320 to execute processing using the attribute information B.

In step S630, the monitoring module 155 monitors access to the resource, that is, the processing apparatus C1 320.

In step S632, the processing apparatus C1 320 provides the processing results to the processing execution module 150.

In step S634, the processing execution module 150 provides the processing results of the logic (requiringUserInfoOperation1) to the processing control module 145.

In step S636, the processing control module 145 provides the processing results of the logic (requiringUserInfoOperation1) to the processing control module 225.

Prior to step S618 or as part of step S616, the processing apparatus B 200 generates logic 810 from a logic definition 710.

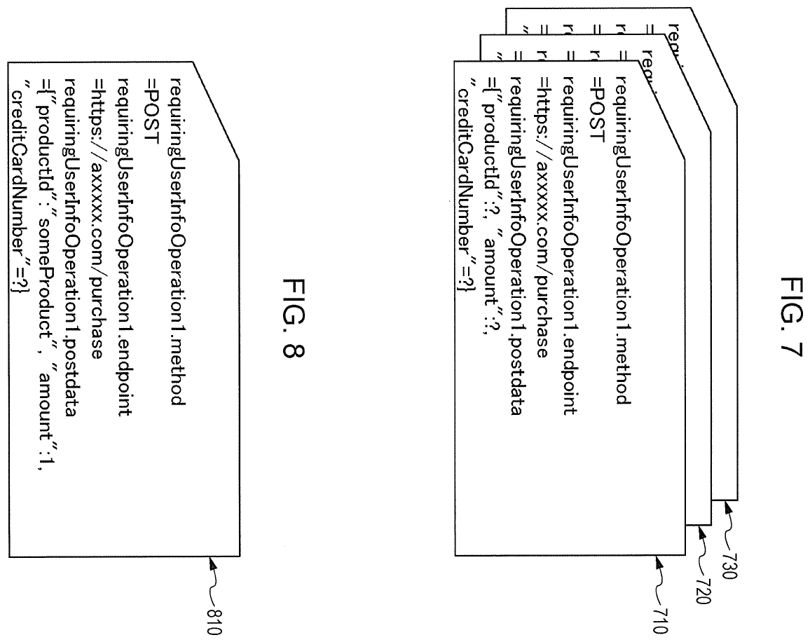

FIG. 7 illustrates an example of the logic definition 710 handled in the exemplary embodiment. The logic definition 710 is a form (also called a template) which defines logic and is formed in advance.

In the logic definition 710, the following logic is defined.

requiringUserInfoOperation1.method=POST
requiringUserInfoOperation1.endpoint=https://axxxxx.com/purchase
requiringUserInfoOperation1.postdata={“productId”:?, “amount”:?, “creditCardNumber”=?}

In the logic definition 710, the product ID (productId), the quantity of items (amount), and the credit card number (creditCardNumber) are blank (indicated by “?” in the logic definition 710). After these blanks are filled in, the logic is executed.

The processing apparatus B 200 may prepare multiple logic forms, such as a logic definition 720 and a logic definition 730, as well as the logic definition 710.

FIG. 8 illustrates an example of the logic 810 handled in the exemplary embodiment.

The logic 810 is generated by the processing apparatus B 200 based on the logic definition 710.

In the logic 810, the following logic is defined.

requiringUserInfoOperation1.method=POST
requiringUserInfoOperation1.endpoint=https://axxxxx.com/purchase
requiringUserInfoOperation1.postdata={“productId”:“someProduct”, “amount”:1, “creditCardNumber”=?}

The value (someProduct) is input into the product ID (productId), which has remained blank, and the value (1) is input into the quantity of items (amount), which has remained blank. These values are contained in a request from the processing apparatus A 100 and can be extracted from the request. The credit card number (creditCardNumber) is left blank because the processing apparatus B 200 has failed to obtain the credit card number from the information providing apparatus 310. The credit card number corresponds to the attribute information B in processing executed in step S614. The logic 810 is then sent to the processing apparatus A 100 in step S618.

The processing apparatus A 100 extracts the credit card number from the user attribute information storage module 120 in steps S622 and S624. The processing apparatus A 100 then inputs the credit card number into the field of the credit card number (creditCardNumber) of the logic 810 after step S624 (as part of step S626). Then, the logic 810 that is ready to be executed has been completed. With the use of the completed logic 810, processing is executed in step S628. That is, the processing apparatus A 100 requests the processing apparatus C1 320 to execute purchase processing.

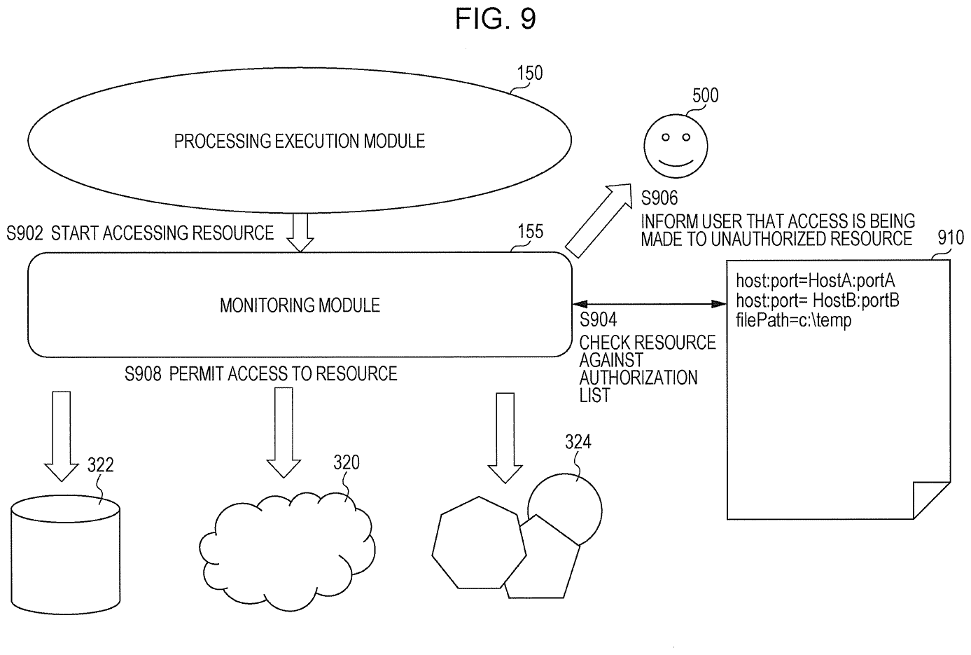

A processing example of step S630 in the flowchart of FIG. 6B will be discussed below in detail with reference to FIG. 9. FIG. 9 illustrates an example of processing executed in accordance with the exemplary embodiment.

In accordance with the logic 810, the processing execution module 150 accesses the processing apparatus C1 320, the processing apparatus C2 322, or the processing apparatus C3 324, which are resources. For example, the processing apparatus C1 320 is a cloud system, the processing apparatus C2 322 is a file system, and the processing apparatus C3 324 is a server that can execute a process. When the processing execution module 150 accesses one of these resources, the monitoring module 155 judges whether the resource is included in an authorization list 910.

The authorization list 910 is the following whitelist, for example. The authorization list 910 is stored in the authorization list storage module 122.

host:port=HostA:portA
host:port=HostB:portB
filePath=c:\temp

In the authorization list 910, the ports of servers (HostA:portA, HostB:portB) that the processing apparatus A 100 can request to execute processing and the file system (c:\temp) that the processing apparatus A 100 can access are indicated.

In step S902, the processing execution module 150 starts processing for accessing a resource.

In step S904, the monitoring module 155 checks the resource that the processing execution module 150 is accessing against the authorization list 910 and judges whether this resource is an authorized resource.

In step S906, if this resource is not included in the authorization list 910, the monitoring module 155 notifies the user 500 that access is being made to an unauthorized resource.

In step S908, if the resource is included in the authorization list 910, the monitoring module 155 permits the processing execution module 150 to access this resource.

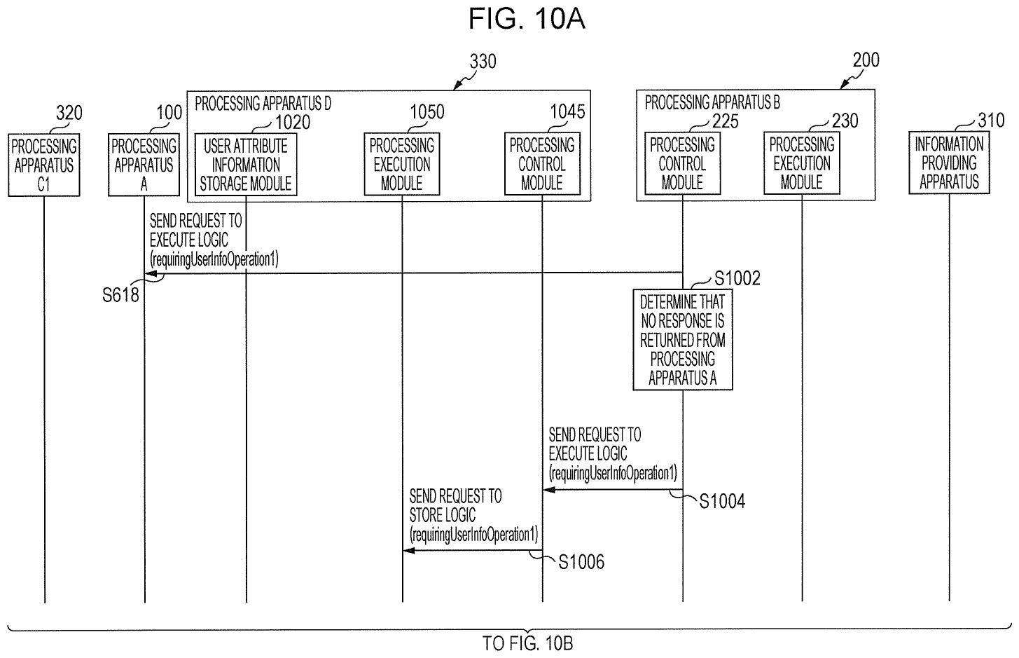

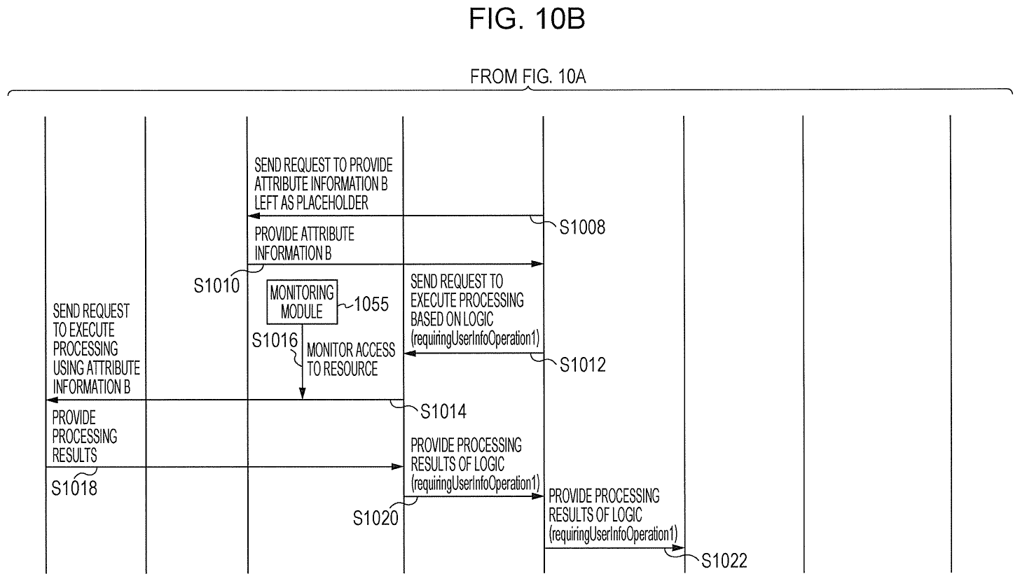

FIGS. 10A and 10B are a flowchart illustrating an example of processing executed in accordance with the exemplary embodiment.

The processing apparatus D 330 has a function of backing up data and programs stored in the processing apparatus A 100, that is, the processing apparatus D 330 stores the data in the data memory 115 and the programs in the program memory 125 of the processing apparatus A 100.

The processing apparatus D 330 includes a user attribute information storage module 1020, a processing control module 1045, a processing execution module 1050, and a monitoring module 1055.

As discussed with reference to FIG. 3, there may be a case in which the processing apparatus B 200 tries but fails to access the processing apparatus A 100 because the processing apparatus A 100 is powered OFF after step 5516 in FIG. 6A. An example of processing executed to deal with such a situation will be discussed.

The user attribute information storage module 1020 corresponds to the user attribute information storage module 120 of the processing apparatus A 100, the processing control module 1045 corresponds to the processing control module 145 of the processing apparatus A 100, the processing execution module 1050 corresponds to the processing execution module 150 of the processing apparatus A 100, and the monitoring module 1055 corresponds to the monitoring module 155 of the processing apparatus A 100. That is, the processing apparatus D 330 is able to execute processing on behalf of the processing apparatus A 100.

The user attribute information storage module 1020 of the processing apparatus D 330 stores, as a backup, information concerning user attributes stored in the user attribute information storage module 120 of the processing apparatus A 100. That is, the user attribute information storage module 1020 stores undisclosed attribute information in the processing apparatus A 100 as a copy.

If the processing apparatus B 200 becomes unable to communicate with the processing apparatus A 100 after having received a request to execute processing from the processing apparatus A 100, the processing control module 225 sends information concerning processing to the processing apparatus D 330 instead of the processing apparatus A 100.

Upon receiving the information concerning processing from the processing control module 225, the processing execution module 1050 of the processing apparatus D 330 adds information concerning user attributes stored in the user attribute information storage module 1020 to the received information concerning processing, and then executes processing by using this information.

Steps S1004 through S1022 in FIGS. 10A and 10B correspond to steps S618 through S636 in FIG. 6B.

In step S618 in FIG. 10A, the processing control module 225 of the processing apparatus B 200 requests the processing apparatus A 100 to execute the logic (requiringUserInfoOperation1). However, the processing apparatus A 100 is unable to communicate with the processing apparatus B 200 because it is powered OFF, for example.

In step S1002, the processing control module 225 determines that no response is returned from the processing apparatus A 100.

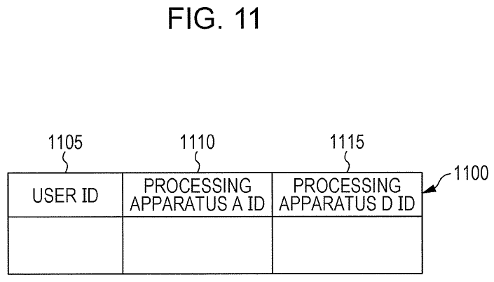

In this case, the processing control module 225 selects the processing apparatus D 330, which is a backup server of the processing apparatus A 100, and executes processing which would normally be done for the processing apparatus A 100. The processing control module 225 selects the processing apparatus D 330 by using a management table 1100, for example. FIG. 11 illustrates an example of the data structure of the management table 1100. The management table 1100 is stored in the processing apparatus B 200. The management table 1100 has a user ID field 1105, a processing apparatus A ID field 1110, and a processing apparatus D ID field 1115. The user ID field 1105 stores information (user ID) for uniquely identifying a user in the exemplary embodiment. The processing apparatus A ID field 1110 stores the ID of the processing apparatus A 100. The processing apparatus D ID field 1115 stores the ID of the processing apparatus D 330. That is, the management table 1100 indicates which processing apparatus (that is, the processing apparatus D 330) can be an alternative to the processing apparatus A 100 or the user using the processing apparatus A 100. In step S1002, the processing control module 225 extracts from the management table 1100 the ID of the processing apparatus D 330 associated with the ID of the processing apparatus A 100, which has not responded to the request, or with the ID of the user 500 of the processing apparatus A 100.

In step S1004, the processing control module 225 requests the processing control module 1045 to execute the logic (requiringUserInfoOperation1). That is, the processing control module 225 requests the processing apparatus D 330 to act for the processing apparatus A 100 or the user 500 using the processing apparatus A 100.

In step S1006, the processing control module 1045 requests the processing execution module 1050 to store the logic (requiringUserInfoOperation1).

In step S1008, the processing control module 1045 requests the user attribute information storage module 1020 to provide the attribute information B which is left as a placeholder (blank).

In step S1010, the user attribute information storage module 1020 provides the attribute information B to the processing control module 1045.

In step S1012, the processing control module 1045 requests the processing execution module 1050 to execute processing based on the logic (requiringUserInfoOperation1).

In step S1014, the processing execution module 1050 requests the processing apparatus C1 320 to execute processing using the attribute information B.

In step S1016, the monitoring module 1055 monitors access to the resource, that is, the processing apparatus C1 320.

In step S1018, the processing apparatus C1 320 provides the processing results to the processing execution module 1050.

In step S1020, the processing execution module 1050 provides the processing results of the logic (requiringUserInfoOperation1) to the processing control module 1045.

In step S1022, the processing control module 1045 provides the processing results of the logic (requiringUserInfoOperation1) to the processing control module 225.

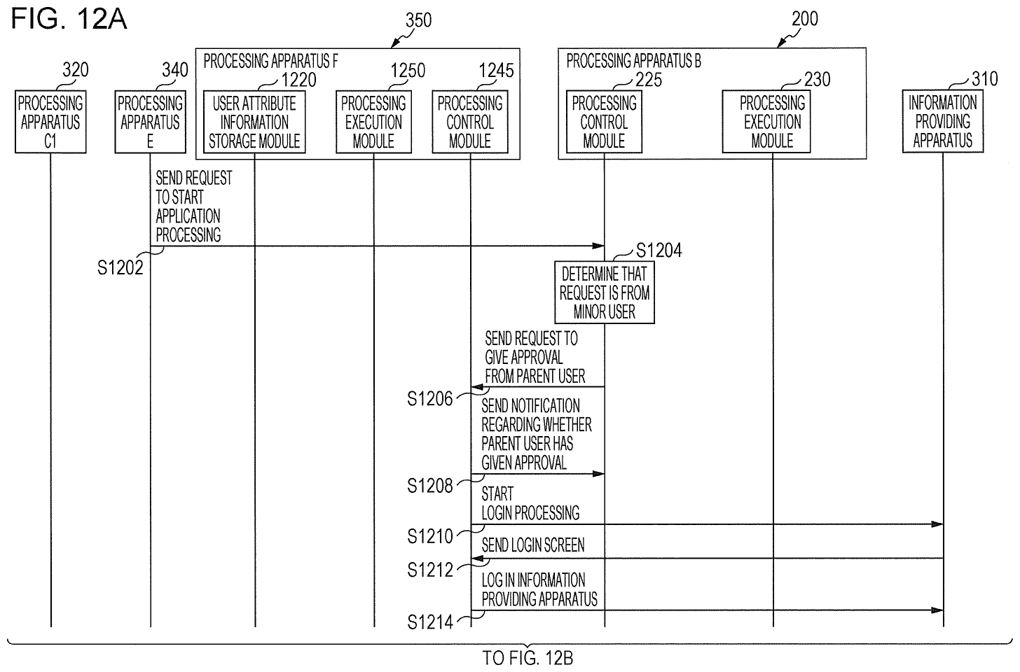

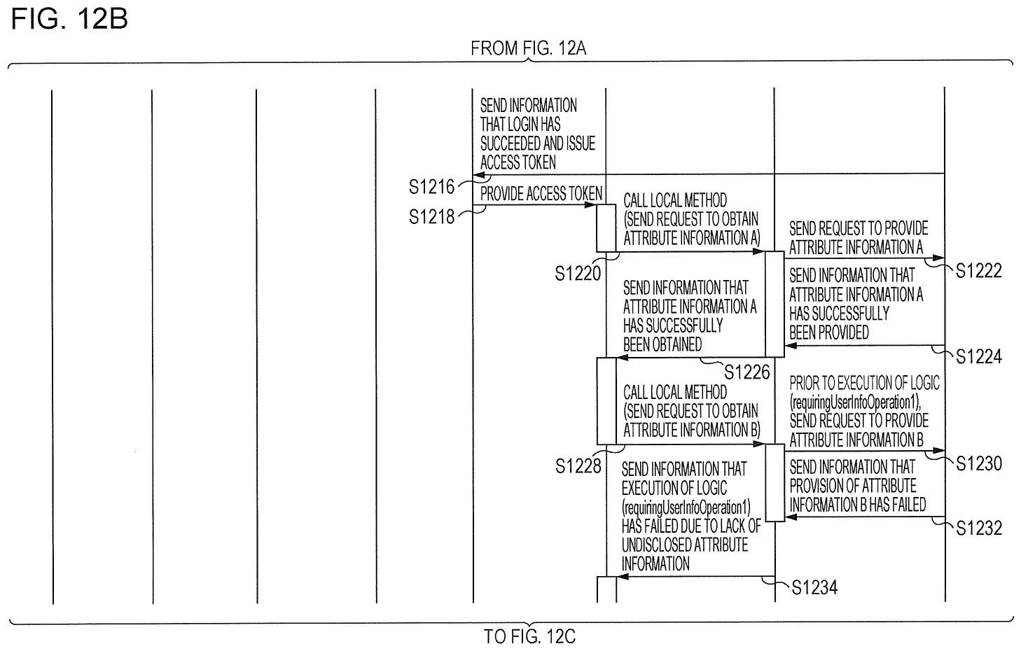

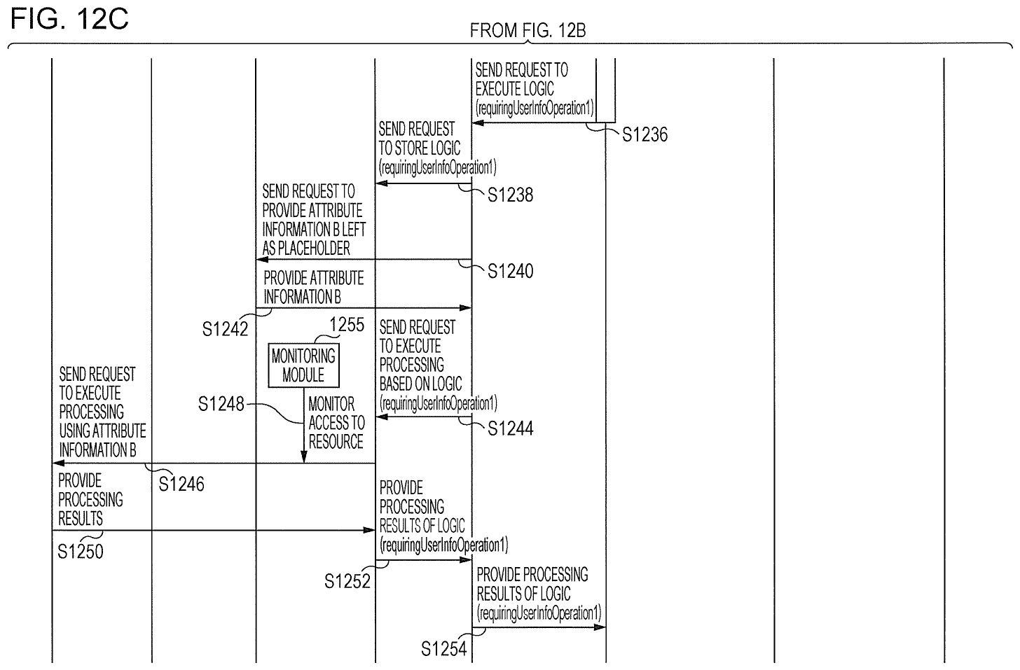

FIGS. 12A, 12B, and 12C are a flowchart illustrating an example of processing executed in accordance with the exemplary embodiment.

It is assumed that processing to be executed in response to a user operation using the processing apparatus E 340 requires undisclosed attribute information concerning the user of the processing apparatus F 350. An example of processing executed in this situation will be discussed below. The user of the processing apparatus E 340 (an example of a first user) is a minor user without a credit card, while the user of the processing apparatus F 350 (an example of a fifth user) is a parent user, who is a parent of this minor user, and possesses a credit card. In a specific example, the minor user of the processing apparatus E 340 requests the processing apparatus B 200 to execute purchase processing, and uses the credit card of the parent user of the processing apparatus F 350 to make a payment.

The processing apparatus E 340 has functions equivalent to those of the processing apparatus A 100. In the processing apparatus E 340, however, undisclosed attribute information required for the processing apparatus B 200 to execute processing is not stored.

The processing apparatus F 350 includes a user attribute information storage module 1220, a processing control module 1245, a processing execution module 1250, and a monitoring module 1255. The user attribute information storage module 1220 corresponds to the user attribute information storage module 120 of the processing apparatus A 100, the processing control module 1245 corresponds to the processing control module 145 of the processing apparatus A 100, the processing execution module 1250 corresponds to the processing execution module 150 of the processing apparatus A 100, and the monitoring module 1255 corresponds to the monitoring module 155 of the processing apparatus A 100.

The user attribute information storage module 1220 stores attribute information concerning the parent user of the processing apparatus F 350. That is, the user attribute information storage module 1220 stores undisclosed attribute information concerning the parent user using the processing apparatus F 350.

It is now assumed that, when the processing apparatus B 200 executes processing in response to a request from the processing apparatus E340, it requires information concerning an attribute of the fifth user but is unable to receive it from the information providing apparatus 310. In this case, the processing control module 225 generates information concerning processing without including information concerning this attribute of the fifth user, and sends this information to the processing apparatus F 350.

Upon receiving the information concerning processing from the processing control module 225, the processing execution module 1250 of the processing apparatus F 350 adds information concerning the attribute of the fifth user stored in the user attribute information storage module 1220 to the received information concerning processing, and then executes processing by using this information.

In step S1202, the processing apparatus E 340 requests the processing control module 225 of the processing apparatus B 200 to start application processing.

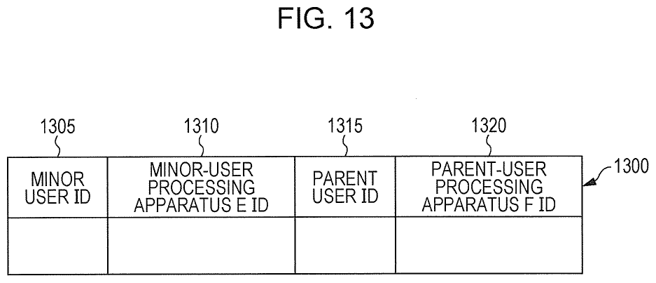

In step S1204, the processing control module 225 determines that the request received in step S1202 is from a minor user. The processing control module 225 makes this determination by using a parent-minor management table 1300. FIG. 13 illustrates an example of the data structure of the parent-minor management table 1300. The parent-minor management table 1300 has a minor user ID field 1305, a minor-user processing apparatus E ID field 1310, and a parent user ID field 1315, and a parent-user processing apparatus F ID field 1320. The minor user ID field 1305 stores the ID of a minor user. The minor-user processing apparatus E ID field 1310 stores the ID of the processing apparatus E 340 used by the minor user. The parent user ID field 1315 stores the ID of a parent user, who is a parent of the minor user. The parent-user processing apparatus F ID field 1320 stores the ID of the processing apparatus F 350 used by the parent user. That is, the parent-minor management table 1300 manages a pair of the ID of a minor user and the ID of a parent user and a pair of the ID of the processing apparatus used by the minor user and the ID of the processing apparatus used by the parent user. If the request received in step S1202 is found to be from the processing apparatus E 340 of the minor user, the process proceeds to step S1206.

In step S1206, the processing control module 225 sends a request to give approval of the parent user to the processing control module 1245. The request may include information concerning the product to be purchased by the minor user and its price, for example.

In step S1208, the processing control module 1245 notifies the processing control module 225 whether the parent user has given approval, in accordance with an operation of the parent user. It is assumed that the parent user has given approval. This processing may be replaced by processing for sending a request to log in the information providing apparatus 310 from the processing apparatus B 200. If the processing apparatus F 350 has logged in the information providing apparatus 310, that is, if an access token is provided to the processing apparatus B 200, the processing apparatus B 200 may determine that the parent user has given approval. The processing apparatus B 200 may always determine that the parent user has given approval to a request from the minor user.

Steps S1210 through S1218 correspond to steps S508 through S516 in FIG. 5, and steps S1220 through S1254 correspond to steps S602 through S636 in FIGS. 6A and 6B. In FIGS. 12A through 12C, however, the parent user does not request the processing apparatus B 200 to start application processing by itself.

In step S1210, the processing control module 1245 starts login processing to log in the information providing apparatus 310.

In step S1212, the information providing apparatus 310 sends a login screen to the processing control module 1245.

In step S1214, the processing control module 1245 logs in the information providing apparatus 310.

In step S1216, the information providing apparatus 310 notifies the processing control module 1245 of the success of the login operation and issues an access token.

In step S1218, the processing control module 1245 provides the access token to the processing control module 225.

In step S1220, the processing control module 225 gives a local method call to the processing execution module 230. In other words, the processing control module 225 sends a request to obtain the attribute information A to the processing execution module 230.

In step S1222, the processing execution module 230 sends a request to provide the attribute information A to the information providing apparatus 310.

In step S1224, the information providing apparatus 310 notifies the processing execution module 230 that the user attribute information A has successfully been provided.

In step S1226, the processing execution module 230 notifies the processing control module 225 that the user attribute information A has successfully been obtained.

In step S1228, the processing control module 225 gives a local method call to the processing execution module 230. In other words, the processing control module 225 sends a request to obtain the attribute information B to the processing execution module 230.

In step S1230, prior to the execution of the logic (requiringUserInfoOperation1), the processing execution module 230 sends a request to provide the attribute information B to the information providing apparatus 310.

In step S1232, the information providing apparatus 310 notifies the processing execution module 230 of a failure to provide the attribute information B. This is because the information providing apparatus 310 does not store the attribute information B, which is undisclosed attribute information.

In step S1234, the processing execution module 230 notifies the processing control module 225 that it has failed to execute the logic (requiringUserInfoOperation1) due to the lack of undisclosed attribute information.

In step S1236, the processing control module 225 requests the processing control module 1245 to execute the logic (requiringUserInfoOperation1).

In step S1238, the processing control module 1245 requests the processing execution module 1250 to store the logic (requiringUserInfoOperation1).

In step S1240, the processing control module 1245 requests the user attribute information storage module 1220 to provide the attribute information B which is left as a placeholder (blank).

In step S1242, the user attribute information storage module 1220 provides the attribute information B to the processing control module 1245.

In step S1244, the processing control module 1245 requests the processing execution module 1250 to execute processing based on the logic (requiringUserInfoOperation1).

In step S1246, the processing execution module 1250 requests the processing apparatus C1 320 to execute processing using the attribute information B.

In step S1248, the monitoring module 1255 monitors access to the resource, that is, the processing apparatus C1 320.

In step S1250, the processing apparatus C1 320 provides the processing results to the processing execution module 1250.

In step S1252, the processing execution module 1250 provides the processing results of the logic (requiringUserInfoOperation1) to the processing control module 1245.

In step S1254, the processing control module 1245 provides the processing results of the logic (requiringUserInfoOperation1) to the processing control module 225.

In the above-described example, an application for purchasing a product at a desired price or lower has been discussed as an example of the application used by the processing apparatus B 200. As another example, an application for providing concierge services for booking airline tickets with multiple airline companies and making a payment to them to go on a round-the-world trip may be applicable. In this case, the processing apparatus C1 320, the processing apparatus C2 322, and the processing apparatus C3 324 provide services of airline companies. The processing apparatus A 100 executes payment processing to the individual airline companies by using a credit card number. Registration of the credit card number in the information providing apparatus 310 is not necessary nor is it in the processing apparatus B 200.

The present disclosure may be implemented as the following second processing apparatus.

A second processing apparatus, the second processing apparatus being connected to a first processing apparatus used by a user and to an information providing apparatus so as to communicate with the first processing apparatus and the information providing apparatus, the second processing apparatus including:

at least one processor configured to
generate, in response to a request to execute processing from the first processing apparatus, information concerning the processing without including information concerning an attribute of the user, the information concerning the attribute of the user being information which is necessary for executing the processing and which is impossible for the second processing apparatus to obtain from the information providing apparatus, and
send the generated information concerning the processing to the first processing apparatus.

The second processing apparatus may be configured as follows.

The second processing apparatus requests a third processing apparatus to execute the processing that the first processing apparatus has requested the second processing apparatus to execute in accordance with the information concerning the processing; and

the second processing apparatus determines which processing apparatus serves as the third processing apparatus to execute the processing.

The present disclosure may be implemented as the following non-transitory computer readable medium.

A non-transitory computer readable medium storing a program causing a computer of a second processing apparatus to execute a process, the computer of the second processing apparatus being connected to a computer of a first processing apparatus used by a user and to an information providing apparatus so as to communicate with the computer of the first processing apparatus and the information providing apparatus, the process including:

generating, in response to a request to execute processing from the first processing apparatus, information concerning the processing without including information concerning an attribute of the user, the information concerning the attribute of the user being information which is necessary for executing the processing and which is impossible for the computer of the second processing apparatus to obtain from the information providing apparatus; and

sending the generated information concerning the processing to the first processing apparatus.

The above-described program may be stored in a recording medium and be provided. The program recorded on a recording medium may be provided via a communication medium. In this case, the above-described program may be implemented as a “non-transitory computer readable medium storing the program therein” in the exemplary embodiment.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a CD read only memory (CD-ROM), a CD recordable (CD-R), and a CD rewritable (CD-RW), Blu-ray (registered trademark) disc, a magneto-optical disk (MO), a flexible disk (FD), magnetic tape, a hard disk, a ROM, an electrically erasable programmable read only memory (EEPROM) (registered trademark), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be the entirety or part of another program, or may be recorded, together with another program, on a recording medium. The program may be divided and recorded on plural recording media. The program may be recorded in any form, for example, it may be compressed or encrypted, as long as it can be reconstructed.

In the embodiment above, the term “processor” refers to hardware in a broad sense. Examples of the processor include general processors (e.g., CPU: Central Processing Unit), and dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A first processing apparatus, the first processing apparatus being connected to a second processing apparatus so as to communicate with the second processing apparatus, the second processing apparatus being connected to an information providing apparatus so as to communicate with the information providing apparatus, the first processing apparatus comprising:
a memory that stores information concerning attributes of a user; and
at least one processor configured to
request, in accordance with an operation of the user, the second processing apparatus to execute processing,
add, upon receiving information concerning the processing from the second processing apparatus, information concerning a first attribute of the user stored in the memory to the received information concerning the processing, the information concerning the first attribute of the user being information which is necessary for executing the processing and which is impossible for the second processing apparatus to obtain from the information providing apparatus, and
execute the processing by using the information concerning the processing appended with the information concerning the first attribute of the user.

2. The first processing apparatus according to claim 1, wherein the first processing apparatus requests, via the second processing apparatus, a third processing apparatus to execute the processing that the first processing apparatus has requested the second processing apparatus to execute in accordance with the information concerning the processing, and it is not yet determined which processing apparatus serves as the third processing apparatus to execute the processing.

3. The first processing apparatus according to claim 2, wherein the first processing apparatus adds the information concerning the first attribute of the user to the information concerning the processing received from the second processing apparatus, and sends the information concerning the processing appended with the information concerning the first attribute of the user to the third processing apparatus.

4. A non-transitory computer readable medium storing a program causing a computer of a first processing apparatus to execute a process, the computer of the first processing apparatus being connected to a computer of a second processing apparatus so as to communicate with the computer of the second processing apparatus, the second processing apparatus being connected to an information providing apparatus so as to communicate with the information providing apparatus, the process comprising:
requesting, in accordance with an operation of a user, the second processing apparatus to execute processing;
adding, upon receiving information concerning the processing from the second processing apparatus, information concerning an attribute of the user stored in a memory of the first processing apparatus to the received information concerning the processing, the information concerning the attribute of the user being information which is necessary for executing the processing and which is impossible for the second processing apparatus to obtain from the information providing apparatus; and
executing the processing by using the information concerning the processing appended with the information concerning the attribute of the user.

5. A first processing apparatus, the first processing apparatus being connected to a second processing apparatus so as to communicate with the second processing apparatus, the second processing apparatus being connected to an information providing apparatus so as to communicate with the information providing apparatus, the first processing apparatus comprising:
storage means for storing information concerning attributes of a user;
means for requesting, in accordance with an operation of the user, the second processing apparatus to execute processing;
means for adding, upon receiving information concerning the processing from the second processing apparatus, information concerning a first attribute of the user stored in the storage means to the received information concerning the processing, the information concerning the first attribute of the user being information which is necessary for executing the processing and which is impossible for the second processing apparatus to obtain from the information providing apparatus; and
means for executing the processing by using the information concerning the processing appended with the information concerning the first attribute of the user.
